(19) United States
(12) Patent Application Publication
(10) Pub. No.: US 2014/0222563 A1
(43) Pub. Date: Aug. 7, 2014

(54) Solutions For Hedging Against Foreign-Exchange Currency Risk

(71) Applicants: Raja Ramachandran, Novato, CA (US); Pavan Trikutam, San Francisco, CA (US); Philip Harris, Summit, NJ (US)

(72) Inventors: Raja Ramachandran, Novato, CA (US); Pavan Trikutam, San Francisco, CA (US); Philip Harris, Summit, NJ (US)

(21) Appl. No.: 14/171,201

(22) Filed: Feb. 3, 2014

Related U.S. Application Data
(60) Provisional application No. 61/760,979, filed on Feb. 5, 2013.

(51) Int. Cl. G06Q 40/04; G06Q 30/02

(52) U.S. Cl. CPC G06Q 40/04; G06Q 30/0207
USPC 705/14.53; 705/37; 705/36 R

(57) ABSTRACT

A service providing affinity and rewards to consumers based on their spending abroad to leverage foreign exchange currency gains or losses is described. The service automates the process of exchange rate gain or loss on a product or product category basis. The service may provide marketer incentives to compensate for all or some portion of the currency exchange-based gain or loss, including automated incentive rewards.

### RELATED APPLICATION

This application claims the benefit of U.S. Provisional Patent Application Ser. No. 61/760,979, filed on Feb. 5, 2013.

### FIELD OF THE DISCLOSURE

The present disclosure relates generally to an improved hedging solution against foreign-exchange currency risk. In particular, the present disclosure relates to a service providing information and guidance to consumers to improve their product spending by using unique algorithms to determine the purchasing value of goods and services in both domestic and foreign currency terms.

### BACKGROUND

The problems consumers face related to foreign exchange (FX) currency volatility are well known. While businesses can hedge FX rate volatility and potential losses through their banks or other sophisticated strategies, individuals are often exposed to potential currency exchange losses of 20% or more. And no credit card, foreign exchange or other financial risk mitigation service currently provides individual customer hedging solutions for FX risk.

FX risk is exacerbated because fluctuations of prices in countries vary—sometimes greatly—on a day-to-day and week-to-week basis. This means that at a particular point in time, a consumer may be better off purchasing a specific good or service in a first country and then at a later point in time, the consumer may be better off purchasing the same good or service from a second country. But historically it has been difficult for consumers to obtain the necessary real-time knowledge to best allocate their purchasing resources in more than one country.

Accordingly, there is a need for a system to provide users with a real-time system to hedge against FX risks using an algorithm to determine the purchasing value of goods and services in both domestic and foreign currency terms across more than one country.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a flowchart showing a high-level overview of an algorithm to provide a user with the most optimal purchase decisions in two or more countries, in accordance with some embodiments.

FIG. 2 is a flowchart showing a high-level exemplary overview of a user implementing an algorithm to determine the most optimal purchase decisions in two or more countries, in accordance with some embodiments.

FIGS. 3A through 3F are screenshots demonstrating the implementation of various stages of an algorithm to determine the most optimal purchase decisions in two or more countries, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

A solution to the FX risk for consumers may be achieved by the use of a database and a series of algorithms that automates the process of: (a) capturing brand- and product-pricing globally; (b) calculating and generating exchange rates based on price gains or losses per product category, product and brand; (c) displaying the data results of the same in ranked lists over mobile and web platforms (for which the newly-calculated currency-based purchasing values may serve as content for third-party sites, analytics and reporting to third parties); and (d) aggregating and providing marketer incentives to help relinquish the full or some portion of the currency exchange-based gain or loss.

Further features of the algorithms may include calculation and generation of cross currency-based and/or alternative currency (such as Bitcoin) source-based product pricing differentials. The product differences may exist either in a proprietary database, publicly-available pricing information or be fed directly from private third-party sources such as manufacturers, retailers, or other businesses selling consumer and business related products globally. The algorithm may then identify and rank the best savings as a result of the currency-based calculations based on product item and currency comparison. The application then may allow customers to purchase those items and take advantage of the savings.

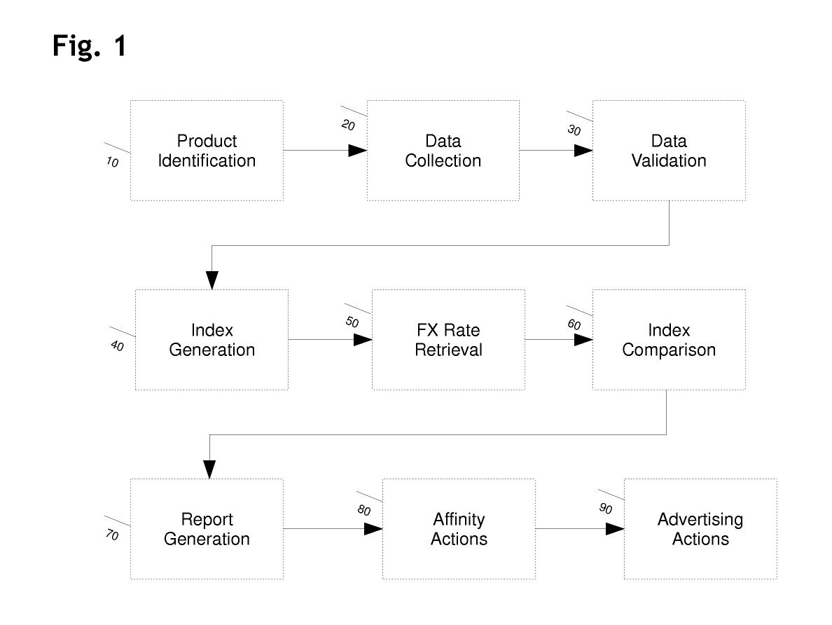

Turning to FIG. 1, shown is an exemplary flowchart outlining the steps that the algorithm may take in order to provide the necessary information for a user to hedge against FX risk and determine the most optimal purchase decision in two or more countries. This algorithm may include a traditional purchasing power parity theory equation S=P₁/P₂ where P₁ represents the selling cost of good “x” in currency 1 and P₂ represents the cost of good “x” in country 2.

The first step of the algorithm is product identification 10. In this step, the algorithm identifies the best products and services for each category that a consumer may desire to purchase. The criteria for choosing these products and categories may include their demand, coverage, and price. Social media, advertising programs or affinity programs may determine which products, brands and categories from which countries will be offered to the user.

As part of this step, the necessary infrastructure is set up to calculate, store and display pricing disparities of global consumer and business products based on the foreign exchange rates of two or more corresponding countries. To do so, a database may be established with the following tables and attributes:

1. product category, manufacturer brand, and product specific item information;

2. currency rate table to include each currency per country and having multiply or divide capability to calculate the currency cross rate or alternative monetary value rate (i.e., Bitcoin);

3. product category table with product category price input; and

4. product-specific table with product identification number, name, price and distribution location.

The second step of the algorithm is data collection 20. Using crowdsourcing techniques and search parameters, the algorithm may collect data on all its products from all the countries it currently tracks, including data from multiple websites and of people that provide such data. This may include the automation of collection of product-specific prices over the web or crowd-sourced physically through the input of that data on a web or mobile application in real time showcasing the purchasing value and or any converted incentives in real time. This may also include end-user, crowd-sourcing pricing input capability for product category and/or product-specific prices in multiple cities globally.

Data providers may be incented to provide price, brand, category and item data in various countries via rewards (tangible or intangible), purchasing credits, affinity programs or other recognition within the algorithm.

The third step of the algorithm is data validation 30. The algorithm validates data collected from the previous step at the price-by-price level to ensure the level of accuracy of the data. Validation may include capturing product pricing data through a third party service and comparing that data with data already in the database.

The fourth step of the algorithm is index generation 40. The algorithm aggregates prices to form indexes on selected brands and categories. In so doing, the algorithm may provide better results for the user because the analysis will be based on pricing data from a “smoother” data set. Such a data set may be more accurate because the data that is more towards the median of the data set is given greater weight than data that is far higher or lower than the median. The index step may include the use of dynamic databases containing global marketer product categories, brand-specific and product-item taxonomy and indexation.

The fifth step of the algorithm is FX rate retrieval 50. The algorithm retrieves and stores foreign exchange rates for all currencies in all countries being tracked. The FX data may be obtained from paid or free third-party sources. This ensures that the product and value comparisons performed by the algorithm are current and up to date.

The sixth step of the algorithm is index comparison 60. The algorithm runs an analysis and comparison for all indexes across countries to identify value disparities and provide insights into purchasing power.

The algorithm may create and calculate varying benchmarks, or indices, based on the weighted average cost of a basket of goods associated with a profile of an end consumer based on his or her spending behavior. The algorithm may generate and calculate infinite profiles and benchmarks, which are then used to determine what the price of those products, should be, based on purchasing power theory. These benchmarks may then be used to analyze gains or losses due to currency exchange impact as information for internal comparisons. They may also be used for commercial purposes as services to third parties in analytics and research, distributed information content and commerce. This value may be broadly represented by the following formula where the weighted mean value of x_{Ω} represents the index of a country, brand, product or user profile.

$${\overline{x}}_{w} = \frac{{\sum }_{i = 1}^{n} ( {w}_{i} {x}_{i} )}{{\sum }_{i = 1}^{n} ( {w}_{i} )}$$

where as
   x̅_{w} is the weighted mean variable
   wᵢ is the allocated weighted value
   xᵢ is the observed values

The seventh step of the algorithm is report generation 70. After running the analyses and comparisons described above, the algorithm generates reports and visualizations to provide the user with the findings of the algorithm. The algorithm may calculate and display product category, brand and product specific comparative values of alternative monetary value exchange rates (like Bitcoin), loyalty reward points, opportunity costs of savings, discounts, and other non-monetary forms of value. The algorithm may also rank and displays the values by product category, brand and specific item. This data may then be distributed to other web sites, applications and mobile devices.

The greatest of those pricing disparities may then be ranked based on the largest gains via currency pair and product and are then displayed to customers for purchase over the web, mobile, or other online applications. The algorithm may also calculate the same values but against alternative monetary value units, such as Bitcoin or other incentive value units such as loyalty rewards points, rebates, coupons, product promotions, giveaways, and other such marketer incentives to effectively reduce the economic loss due to currency exchange rate risk.

In addition, the algorithm may rank the greatest product purchase loss per specific country pair, which then serves as virtual inventory for the company to offer a retailing or commerce service to consumers either directly or through third parties. The algorithm may also be applied to create the purchasing values based on the two countries selected and the products chosen. The algorithm may store the purchasing value with the currency exchange rate, time stamp and date.

The eighth step of the algorithm is affinity actions 80. In this step, the algorithm uses affinity or other reward programs to provide incentives for user to use the algorithm in preferred manner. Additional rewards may be given to users that voluntarily provide their personal information or other information or for users that use social media. Such information may include a customer record including name, email address and home city provided by the user and stored along with marketer/manufacturer incentive unit values, algorithm calculations for the currency exchange rates based value of a product item gain or loss.

The ninth step of the algorithm is advertising actions 90. In this step, the algorithm may provide advertisers with the opportunity to display targeted ads to users related to the goods they are seeking or the countries they are travelling to. Advertisers may also provide discounts or coupons to users based on their travel or brand preferences. The algorithm may provide that revenue generated by the advertisements are distributed to the algorithm owner as well as the advertiser or the advertiser's agents.

The algorithm may also combine and identify an economic value specific to a customer's cross-border purchase of goods and or services, determine the purchasing power value of the product from one country to another and determine the gain or loss. The algorithm may also convert that gain or loss into an incentive and then allow third-party marketers to participate in reducing the foreign exchange gain or loss to the end customer through application marketer incentives to the customer either on demand—at the moment of purchase—or periodically based on the marketer's policies. This type of algorithmic automation provides a novel manipulation of foreign currency (or alternative currency) rate gains or losses to allow for marketer incentives.

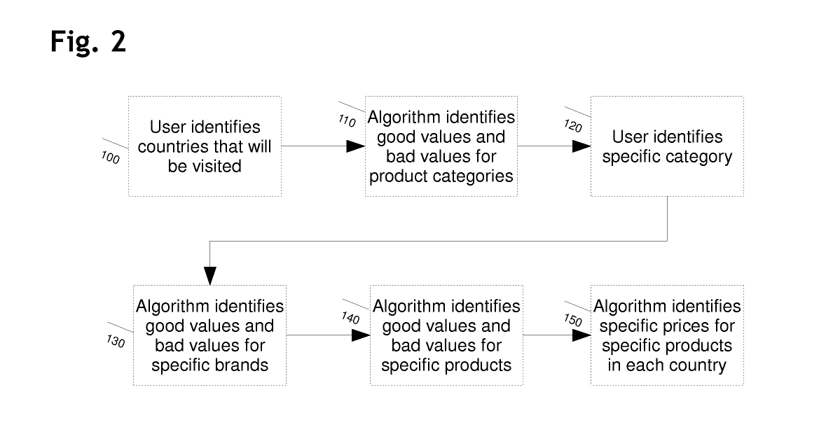

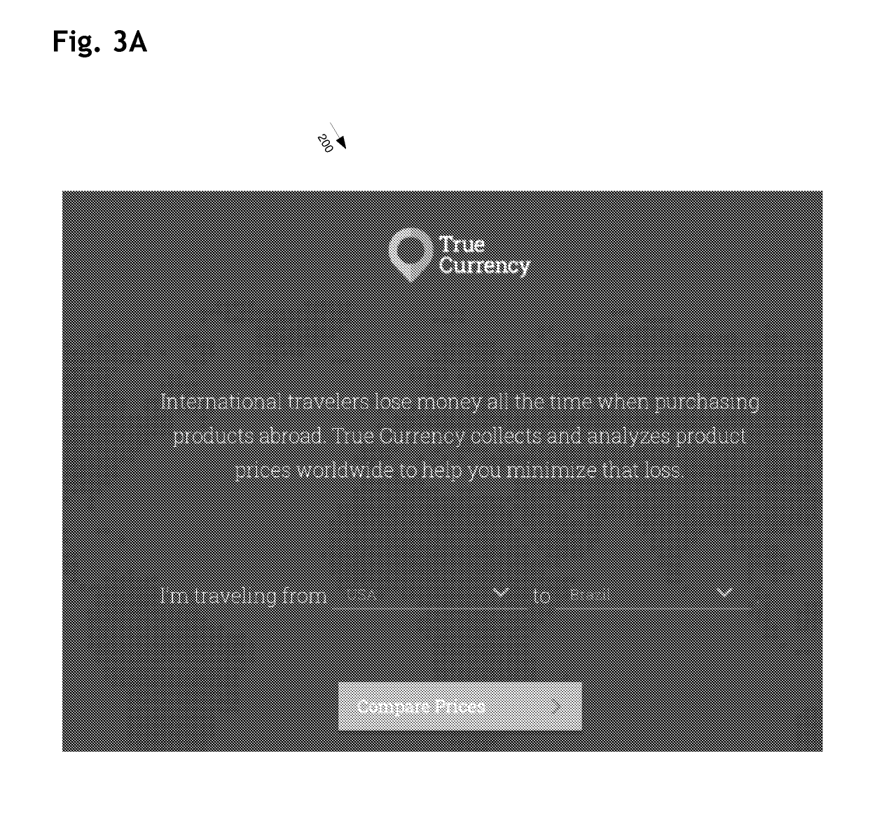

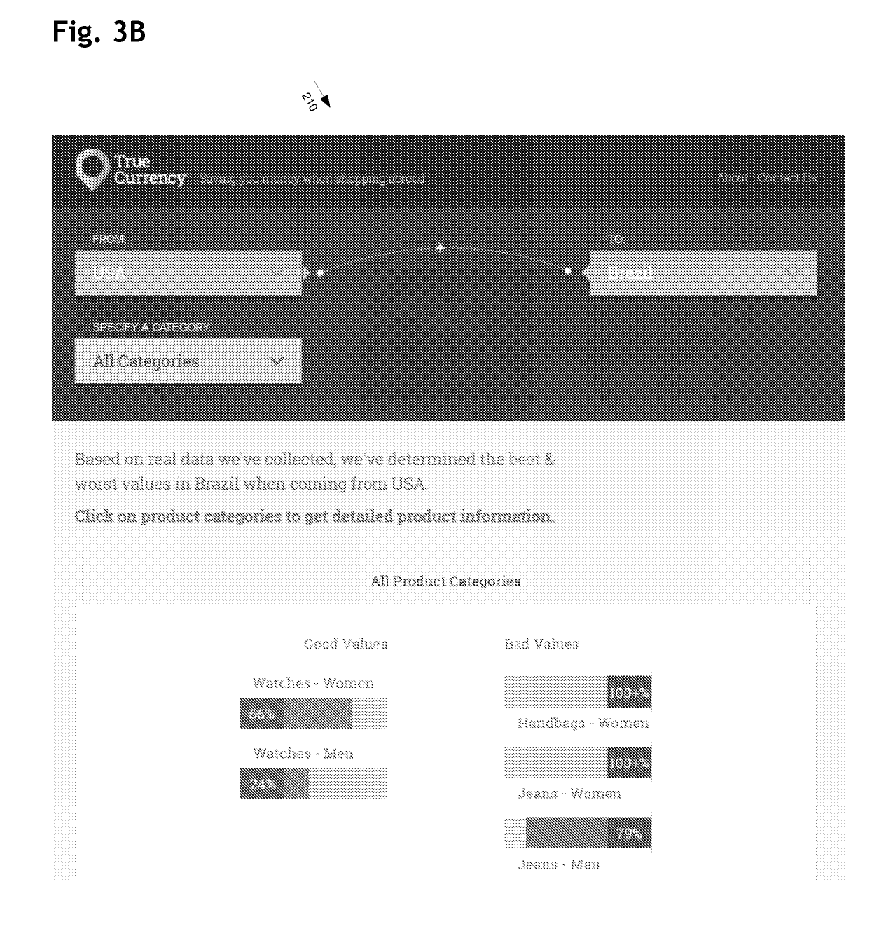

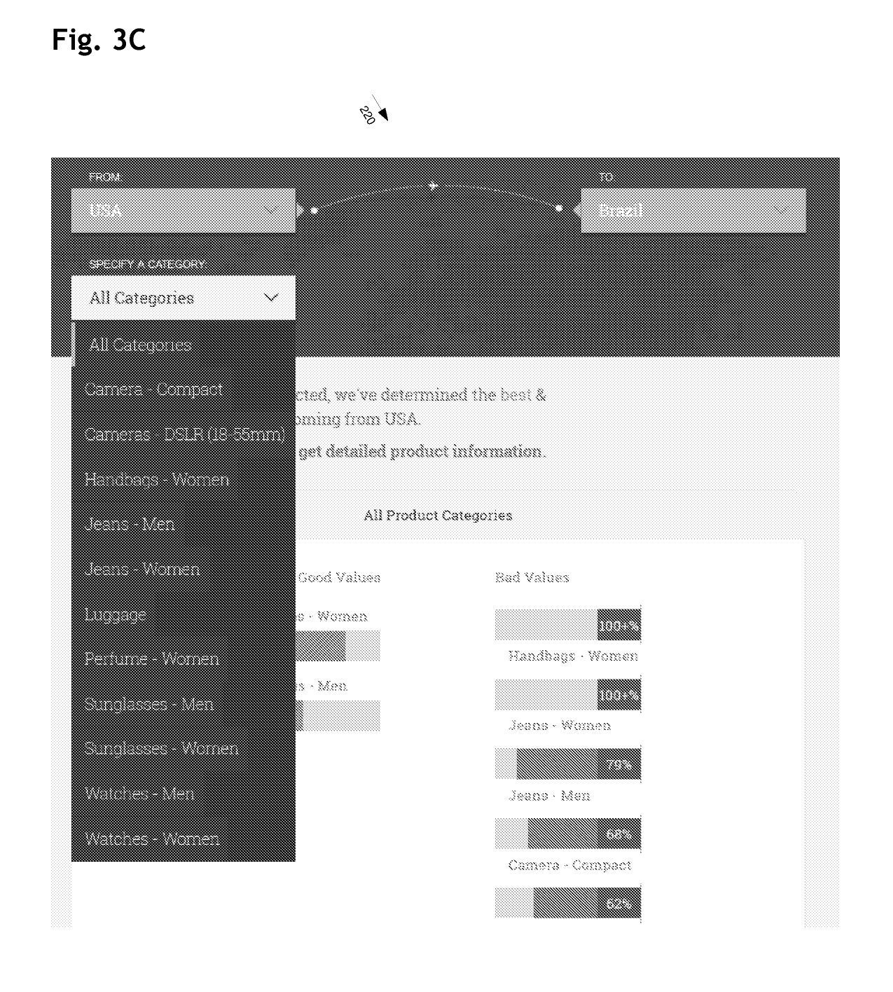

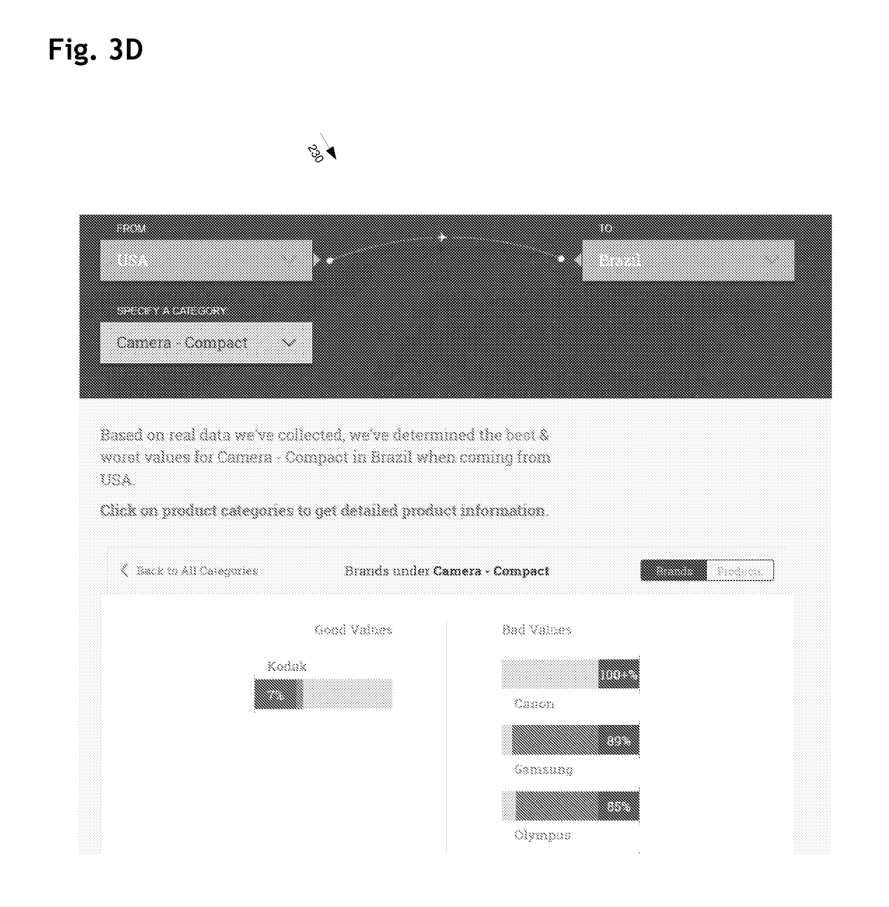

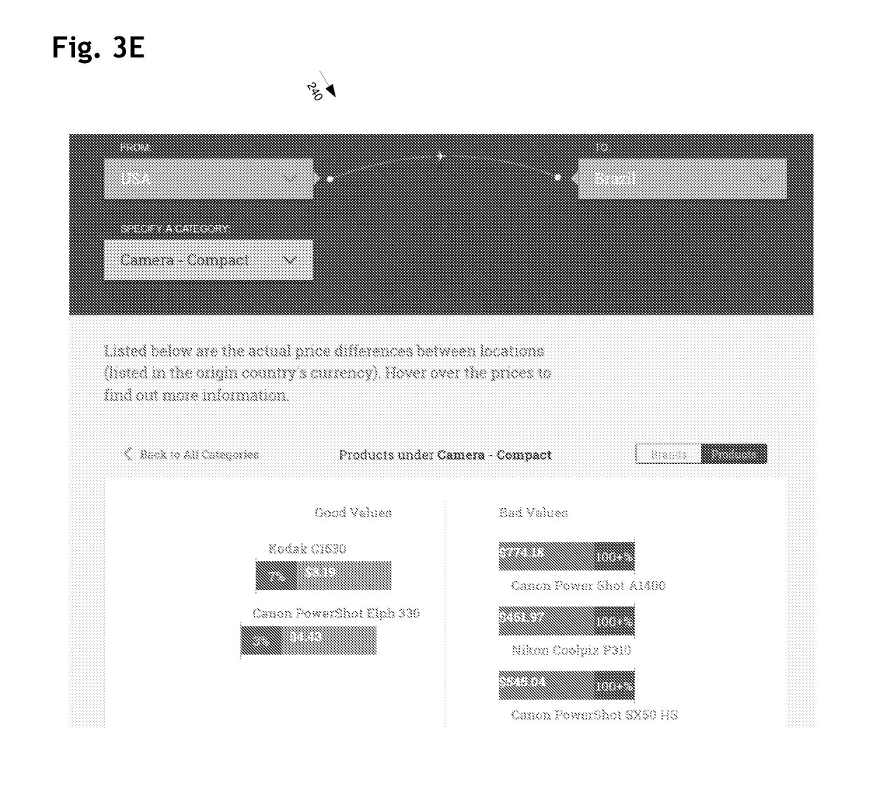

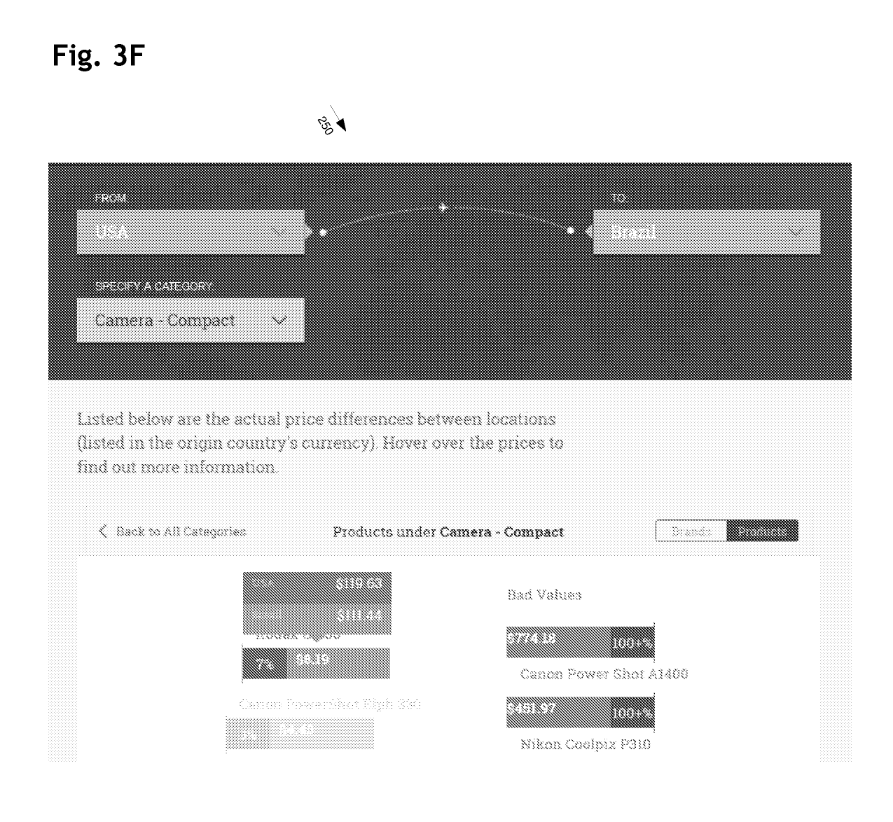

Turning to FIG. 2, shown is a flowchart of the operation of an algorithm from the user's perspective to provide the necessary information for a user to hedge against FX risk and determine the most optimal purchase decision in two or more countries. The six steps of FIG. 2 are further exemplified by the six screenshots shown respectively in FIGS. 3A through 3F.

In the first step of the user experience, the user identifies the two or more countries he or she will be visiting 100. For example, a user may inform the algorithm that he or she will be travelling form the United States to Brazil 200. This may be accomplished by having the user click on a URL and indicating his or her home currency and destination country. Or upon log in, the user may also be shown a first screen showcased in matrix form as product categories, the customer's home city, the foreign destination city and a column that represents the cost of the common good in the home currency along with the gain or loss in the home currency.

In the second step of the user experience, for a number of categories of goods, the algorithm identifies whether purchasing such goods in the second country will result in a better deal or worse deal for the user 110. For example, the algorithm may inform the user that purchasing women's watches and men's watches in Brazil will result in a better value than in the US and that purchasing women's handbags, women's jeans and men's jeans in Brazil will result in a worse value than in the US 210.

In the third step of the user experience, the user may choose a specific category of goods in order to obtain more specific information about those goods 120. For example, the user may choose from various consumer goods such as cameras, handbags, jeans, luggage, perfume, sunglasses and watches 220.

In the fourth step of the user experience, for a number of specific brands within a category, the algorithm identifies whether purchasing such brands in the second country will result in a better deal or worse deal for the user 130. For example, the algorithm may inform the user that purchasing a Kodak compact camera in Brazil will result in a better value than in the US and that purchasing a Canon, Samsung or Olympus compact camera in Brazil will result in a worse value than in the US 230.

In the fifth step of the user experience, for a number of specific products within a category, the algorithm identifies whether purchasing such goods in the second country will result in a better deal or worse deal for the user 140. For example, the algorithm may inform the user that purchasing a Kodak C1530 compact camera and a Canon PowerShot Elph 330 camera in Brazil will result in a better value than in the US and that purchasing a Canon PowerShot A1400, Canon PowerShot SX50 H and a Nikon Coolpix P310 will result in a worse value than in the US 240.

In the sixth step of the user experience, the user may obtain information about specific prices for specific products in each country 150. For example, the algorithm may inform a user that the price for a Kodak C1530 camera in the US is US$119.63 and the equivalent of US$111.44 in Brazil 250.

The algorithms may also be engaged to construct a web page display of comparisons of price disparity values between the two countries at a product category level and brand level. The gains or losses in product values of the destination country versus the home country may be represented by percentages.

The user may also input a price paid for a product category or specific item in the application so that the algorithm calculates and displays the cost of the item in the home currency and also calculates and displays the currency exchange rate based gain or loss associated with the product. The user may also inquire about a product category or product-specific pricing based on the home currency in a foreign city.

The algorithm may also calculate the incentive units per user for storage, display, accumulation and fulfillment by a marketer. Once the client attains any such incentive units, marketers may use the bidding/auction system to bid on incentive units resulting from the algorithm's calculation and conversion of cross-border product purchase currency exchange rate gains and losses.

The user may also investigate specific product items pricing disparities by clicking on a specific product category. The algorithm may be engaged to generate product item-specific pricing values of gains or losses comparing the destination country versus the home country, or in the case of an alternative form of monetary value, like Bitcoin, the alternative currency/monetary unit value compared to the home country.

Other elements that may be added to the algorithm include using GPS capability for location-based services, a mobile ad server enabling the application to dynamically add marketer mobile ads and or promotions on the mobile interface, a bar code scanning tool to help the user scan a product to be mapped to the database of products to determine the gain or loss based on the customer's home currency. In addition, the application may include an API to make its data and software capabilities open for other programmers or platforms to work with, in whole or part.

The algorithms may be used for all or some of the steps set forth above. It may operate by current user-driven event triggers or operate independently so that the full automation of for incentive unit calculation and statement reconciliation may not be necessary. For example, a user may simply see the expected product price without triggering other aspects of the application by simply using the currency calculator embedded in the algorithm.

The web- or mobile-based application may include a public, or free-use, version requiring no user accounts or sign ups and a private, user account based system for a fee or for no fee. The user may set up an account and identify his or her home city. This may serve as a default for all the currency calculations in their home currency.

If a personalized account is established, the user may be directed to go to a personalized website (that may be known as a “My Twurrl page”) possibly via a “Rewards” icon on the personalized website. On that page, the person may enter specific product purchase per city with a price paid for each product and date executed. The algorithm may calculate the specific product gain or loss for that user. The personalized page may then accumulate the purchase in a database and also keep track of the total balance of incentive units.

Once the user seeks to redeem an incentive unit, the user may click on a redeem button on the application which triggers an API call to the fulfillment partner where the user account record and incentive units they wish to redeem are submitted and the partner then takes on the function of fulfillment, offline, with the customer.

The algorithm that calculates the gain or loss may also include user-driven events where users may input a price paid for a product category, and the algorithm calculates the exchange rate gain or loss based upon the destination country exchange rate and product category price. The database may then update the customer record with the pricing inquiry, resultant calculations for gain and or loss. If the customer has an account associated with the algorithm, the database and code may calculate new rewards to accrue at the account level, and tallies a new total for the latest round of purchase inputs. The algorithm may then be applied to create the purchasing values based on the two countries selected and the products chosen. The algorithm stores the purchasing value with the currency exchange rate, time stamp and date.

The user experience may include some or all of the proceeding steps and may be in a different sequence. The user experience may also include the use of social media and/or being provided with targeted advertising related to the goods or brands that are being compared. The user experience may also include the use of an affinity program including the use of alternative monetary value units, such as Bitcoin or other incentive value units such as loyalty rewards points, rebates, coupons, product promotions, giveaways, and other such marketer incentives to effectively reduce the economic loss due to currency exchange rate risk.

Instead of operating a stand-alone mobile or web-based service, the algorithm may be embedded in other applications as a widget with either full or limited functions to enhance the experience of another application.

To design and implement the algorithm, the skills of a computer programmer, database programmer, web and mobile application designer, business analysts and product managers may be required. They may utilize a series of programming tools such as the Titanium platform, java, web services, HTML, CSS or Apache web server. The development steps may include setting up the data base, web server, domains for the URL, email server, and mobile application code done in Titanium for both the iPhone platform as well as the Android platform.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method comprising:
A) collecting first product data related to a product sold in a first country and second product data related to the product sold in a second country;
B) validating the first product data to produce first validated product data and the second product data to produce second validated product data;
C) indexing the first validated product data to produce first index product data and the second validated product data to produce second index product data;
D) obtaining currency exchange information for the first country to produce first country exchange information and for the second country to produce second country exchange information;
E) analyzing the first index product data, the first country exchange information, the second index product data and the second country exchange information to produce a product analysis; and
F) generating a report related to the product analysis.

2. The method as in claim 1, wherein the first product data and the second product data each comprise product category information, product brand information and product price information.

3. The method as in claim 2, wherein:
A) validating the first product data comprises comparing the product price information of the first product data with pricing data obtained from a source different from the source that provided the first product data; and
B) validating the second product data comprises comparing the product price information of the second product data with pricing data obtained from a source different from the source that provided the second product data.

4. The method as in claim 1, wherein the first index product data and the second index product data are produced using data sets having data on multiple product categories.

5. The method as in claim 1, wherein the product analysis is produced by analyzing benchmarks based on the weighted average cost of a basket of goods associated with a profile of an end consumer's spending behavior.

6. The method as in claim 1, wherein the report comprises comparative pricing of the product in the first country and in the second country.

7. The method as in claim 1, further comprising:
G) tracking usage activity by user;
H) maintaining incentive programs for each user based on the usage activity for that user.

8. The method as in claim 1, further comprising:
G) tracking usage activity by user;
H) displaying advertisements for each user based on the usage activity for that user.

9. The method as in claim 1, further comprising:
G) tracking usage activity by user;
H) based on the usage activity for a user, providing the user an offer to alter the gains and losses due to the currency exchange impact between the first country and the second country.

10. A method comprising:
A) a user identifying a first country and a second country to an algorithm;
B) the algorithm providing at least one category of goods for sale in the first country and the second country;
C) the user choosing at least one category of goods;
D) for each category of goods chosen by the user, the algorithm specifying a differential value showing the extent of a lower price for that category of goods in the first country or in the second country.

11. The method of claim 10, further comprising:
E) for each category of goods chosen by the user, the algorithm specifying a brand of goods within that category of goods and a differential value showing the extent of a lower price for that brand of goods in the first country or in the second country.

12. The method of claim 11, further comprising:
F) for each brand of goods chosen by the user, the algorithm specifying a specific good within that brand of goods and a differential value showing the extent of a lower price for that specific good in the first country or in the second country.

13. The method of claim 10, further comprising:
E) the algorithm providing advertising for the user based on usage of the algorithm by the user.

14. The method of claim 10, further comprising:
E) the algorithm providing incentive programs for the user based on usage of the algorithm by the user.

15. The method of claim 10, further comprising:
E) the algorithm offering the user the opportunity to alter the gains and losses due to the currency exchange impact between the first country and the second country.

16. The method of claim 10, wherein the algorithm calculates indices based on the weighted average cost of a basket of goods associated with a profile of an end consumer's spending behavior.

17. The method of claim 10, further comprising:
E) the algorithm identifying a user location using GPS and providing location-based information based on the user location.

18. The method of claim 10, further comprising:
E) the user providing information to the algorithm using a bar code scanning tool.

19. A data set comprising:
product information data, the product information data including manufacturer information, location information, brand information and pricing information;
wherein the product information data is assembled using a database containing global marketer product categories, brand-specific taxonomy and product-item taxonomy;
currency rate information for a plurality of countries;
product analysis data for determining the differential value of goods sold in more than one country, wherein the product analysis data is compiled by analyzing benchmarks based on the weighted average cost of a basket of goods associated with a profile of an end consumer's spending behavior, the product information data and the currency rate information.

20. The data set as in claim 19 wherein the product information data is further assembled from multiple sources providing real-time inputs.
